(19) United States
(12) Patent Application Publication
(10) Pub. No.: US 2026/0359294 A1
(43) Pub. Date: Nov. 12, 2026

(54) DATA MANAGEMENT AND INTEGRATION SYSTEM

(71) Applicant: TeamCentral, Inc., Cincinnati, OH (US)

(72) Inventors: Marc Johnson, Cleves, OH (US); Andrew D. Park, Cincinnati, OH (US); Ben Millhouse, Piqua, OH (US)

(21) Appl. No.: 19/674,915

(22) Filed: May 12, 2026

Related U.S. Application Data
(60) Provisional application No. 63/804,116, filed on May 12, 2025.

(51) Int. Cl. G06F 16/2452; G06F 16/22; G06F 40/151; G06F 40/284; G06F 40/30

(52) U.S. Cl. CPC G06F 16/24522; G06F 16/2237; G06F 40/151; G06F 40/284; G06F 40/30

(57) ABSTRACT

Methods and systems are described for a data management and integration system. A system for data management and integration can improve task efficiency for business processes. In some embodiments, the data management and integration system can provide deliverables based on natural language requests and/or requests from AI agents.

### CROSS-REFERENCE TO RELATED APPLICATIONS

This application claims priority to U.S. Provisional Application No. 63/804,116, titled "Data Management and Integration System," filed May 12, 2025, which is hereby incorporated by reference in its entirety.

### FIELD OF INVENTION

The present disclosure generally relates to systems and methods for integrating and managing data.

### BACKGROUND

There are many companies engaged in various business practices that use data from varying sources to form insights, reports, and/or other deliverables. Often these business practices provide useful information but are often inefficient and require resources that may be better utilized for other tasks. The data used for these business practices often comes from many different sources and are formatted specifically for its source, making it difficult to make connections between the overall data. This often makes the result of these business practices less accurate, more time-consuming, and otherwise inefficient and/or inaccurate.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a data management and integration system is provided. The system includes a processor and a memory storing instructions that, when executed by the processor, cause the processor to detect a business event in one or more enterprise systems. The processor retrieves business event data from the one or more enterprise systems. The processor converts the business event data to markdown formatted business event data. The processor stores the markdown formatted business event data in a common data model. The processor converts the markdown formatted business event data to a vectorized format.

According to other aspects of the present disclosure, the system may include one or more of the following features. The one or more enterprise systems may comprise one or more of a client relations management system, an enterprise resource planning system, an ecommerce system, a warehouse management system, or a human resource information system. The common data model may comprise one or more data structures organized according to business purpose. The one or more data structures may comprise subcategories including one or more of customers, vendors, items, sales orders, purchase orders, invoices, payments, opportunities, employees, organization units, or inventory transactions. The business event may comprise one or more of new client intake, a new order, an updated order status, an updated payment status, a new opportunity, or an employee addition, promotion, or termination. Converting the business event data to markdown formatted business event data may comprise identifying a structure of the business event data, mapping data elements to markdown syntax, and transforming the business event data into markdown syntax based on an original data format. Converting the markdown formatted business event data to the vectorized format may comprise preprocessing the markdown formatted business event data, tokenizing text within the markdown formatted business event data, embedding tokens by converting the tokens into numerical vectors, indexing and storing the numerical vectors according to the common data model, and implementing search algorithms such that the vectorized format can be used for semantic search.

According to another aspect of the present disclosure, a method performed by a data management and integration system is provided. The method includes receiving a natural language request. The method includes converting the natural language request into embeddings. The method includes performing semantic analysis on the embeddings. The method includes converting a result of the semantic analysis to one or more queries. The method includes retrieving data from a common data model by executing the one or more queries. The method includes generating a deliverable based on the retrieved data.

According to other aspects of the present disclosure, the method may include one or more of the following features. The natural language request may be a text-based request inputted by a user to a large language model. The natural language request may be a request from an AI agent. Converting the natural language request into embeddings may comprise preprocessing the natural language request, tokenizing text within the natural language request, and embedding tokens by converting the tokens into numerical vectors that capture context and meaning. Performing semantic analysis on the embeddings may comprise determining how the embeddings are grouped or classified based on semantic properties. The one or more queries may comprise one or more SQL queries. The deliverable may comprise one or more of a graph, a table, a report, a natural language explanation, or a draft email. The common data model may store normalized data from a plurality of enterprise systems, the normalized data being organized according to business purpose.

According to another aspect of the present disclosure, a method is provided. The method includes generating a user feed for a user of a data integration system, the user feed comprising one or more alerts. The method includes determining alert content for the one or more alerts based on data retrieved from a common data model. The method includes customizing the one or more alerts based on a user profile associated with the user.

According to other aspects of the present disclosure, the method may include one or more of the following features. The user profile may comprise one or more of a role of the user in a company, typical interactions of the user with particular systems, people, or clients, an authorization level of the user, or a location of the user. The method may further comprise generating and maintaining the user profile using a machine learning engine. The method may further comprise generating a user archetype for a particular role and generating the user profile based on the user archetype.

According to another aspect of the present disclosure, a non-transitory computer-readable medium is provided. The non-transitory computer-readable medium stores instructions that, when executed by a processor, cause the processor to perform the method of receiving a natural language request, converting the natural language request into embeddings, performing semantic analysis on the embeddings, converting a result of the semantic analysis to one or more queries, retrieving data from a common data model by executing the one or more queries, and generating a deliverable based on the retrieved data.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a data integration system, according to aspects of the present disclosure.

FIG. 2 illustrates a common data model within a data management server, according to an embodiment.

FIG. 3 illustrates a flowchart for a method for normalizing structured data, according to aspects of the present disclosure.

FIG. 4 illustrates a flowchart for a method for generating a deliverable based on a natural language request, according to an embodiment.

FIG. 5 illustrates an example user interface of a user feed for a data integration system, according to aspects of the present disclosure.

FIG. 6 illustrates a model lifecycle management procedure comprising a training pipeline and an inference pipeline, according to an embodiment.

FIG. 7 illustrates a neural network comprising hidden layers and input/output connections, according to aspects of the present disclosure.

FIG. 8 illustrates a schematic block diagram of a computing device, according to an embodiment.

FIG. 9 illustrates a flowchart of a method for generating customized alerts in a user feed, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in management and integration of structured data for automating business practices. There are numerous companies that often engage in business practices that use data from varying sources to form insights, reports, and/or other deliverables, but do so inefficiently and waste resources that may be better utilized for other tasks. Often newer and/or less skilled employees cannot complete these business practices without significant time and/or guidance as well. As a result, there are numerous opportunities to improve workforce efficiency and reduce resource requirements.

Certain aspects of the embodiments disclosed herein provide solutions to these or other challenges. Certain embodiments include various functionalities. Certain embodiments include aggregating and normalizing structured data from varying sources. Certain embodiments include generating deliverables based on requests. Certain embodiments include artificial intelligence or machine learning (AI/ML) enhanced task performance.

Certain embodiments may provide one or more of the following technical advantages. Embodiments can achieve greater task efficiency, accessibility, and/or accuracy. Certain embodiments can receive requests for performance of one or more business tasks and autonomously perform the task. AI/ML-enabled task management and/or performance are also described.

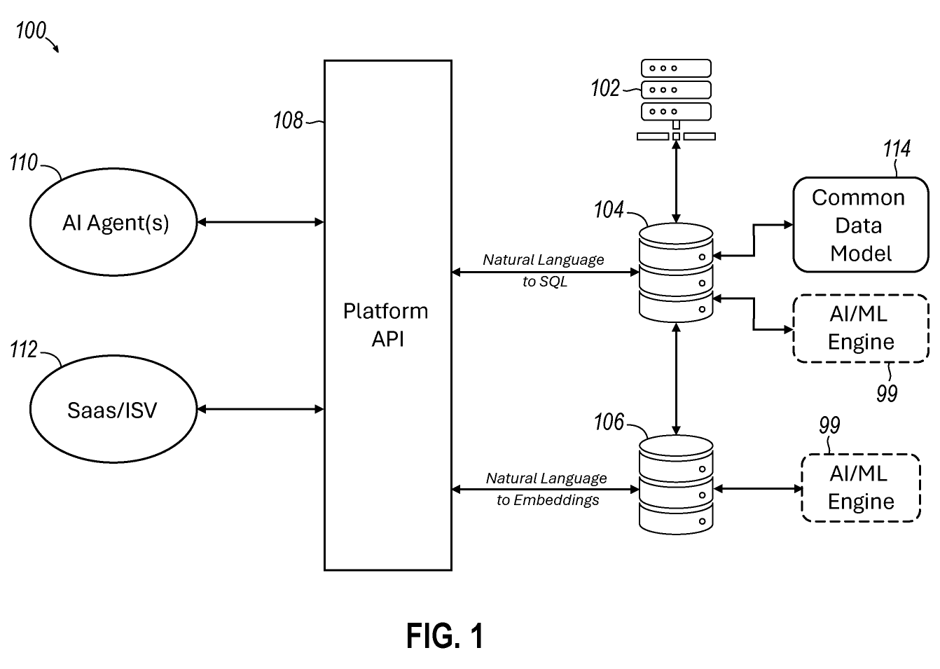

Referring now to FIG. 1, one embodiment of a data management and integration system 100 is shown. Such systems shall simply be referred to as data integration systems for purposes of the present disclosure. Businesses often have many enterprise systems 102 that each may contain structured data formatted for the enterprise system it is housed in. Enterprise systems 102 may include client relations management systems, enterprise resource planning systems, ecommerce systems, warehouse management systems, human resource information systems, or other systems. Data integration system 100 may include these varying enterprise systems 102. To make the structured data from these varying enterprise systems 102 more useful, it may be normalized by a data management server 104 into a common data model. The common data model may include one or more data structures (SQL tables, data arrays, linked lists, stacks, queues, hash tables, trees, graphs, heaps, tries, sets, and/or other data structures). This normalization may include converting the structured data into a markdown format for storage within the common data model such that the data can be stored and searched effectively. Then the data management server 104 may pass the data in markdown format to a semantic search engine 106 such that the semantic search engine 106 can convert the data from markdown format to a vectorized format. This may allow for semantic searching of the structured data, improved insights, and other benefits. The semantic search engine may include VectorMD™, Azure™ AI Search, OpenSearch™, a customized semantic search engine, or other semantic search engines.

An AI agent 110 and/or a software as a service (SaaS) provider/independent software vendor (ISV) 112 may communicate a task request, question, and/or other request in natural language with a business process platform application programming interface (API) 108 via a network (e.g., Internet, cellular, Bluetooth^{TM}, Wi-FI, wired, wireless, satellite, enterprise, private network, similar networks, or combinations of the foregoing). The AI agent 110 and/or SaaS provider/ISV 112 may include Co-Pilot™, Salesforce Einstein™, Chat GPT™, or others. The natural language request may be inputted by a user into a large language model (LLM), voice assistant, speech recognition system, or other communication system. The business process platform API 108 may communicate the natural language request to the semantic search engine 106 such that the semantic search engine 106 can determine the meaning and intent behind the request and convert the natural language request to embeddings. The embeddings may be communicated back to the business process platform API 108 by the semantic search engine 106. The business process platform API 108 may then communicate the embeddings to a data management server 104 such that the data management server 104 can convert the embeddings into one or more SQL queries and/or other queries. In some embodiments, instead of the embeddings being communicated by the business process platform API 108 to the data management server 104, the natural language request may be communicated such that the data management server 104 can convert the embeddings into one or more SQL queries and/or other queries. The queries may be such that the queries can efficiently find and return data relevant to the natural language request and/or embeddings. In some embodiments, the embeddings may be communicated directly from the semantic search engine 106 to the data management server 104. Various embodiments of data integration system 100 may have AI/ML functionalities. AI/ML engine 99 may be stored or operated at various computing devices within data integration system 100. Any or all of the business process platform API 108, data management server 104, and/or semantic search engine 106 may comprise AI/ML engine(s) 99. AI/ML engines 99 may comprise or perform AI/ML functionality as described further herein.

While various components or functionalities of FIG. 1 are illustrated as separate servers/databases/devices, it should be understood that some, many, or all of the components or functionalities may be co-located in certain embodiments. These components of functionalities may be located on cloud and/or physical servers, cloud and/or physical databases, computing systems, ASICs, storage systems, and/or other systems. The illustrated components or functionalities may comprise logical or functional distinctions or entities within a common computing device or system.

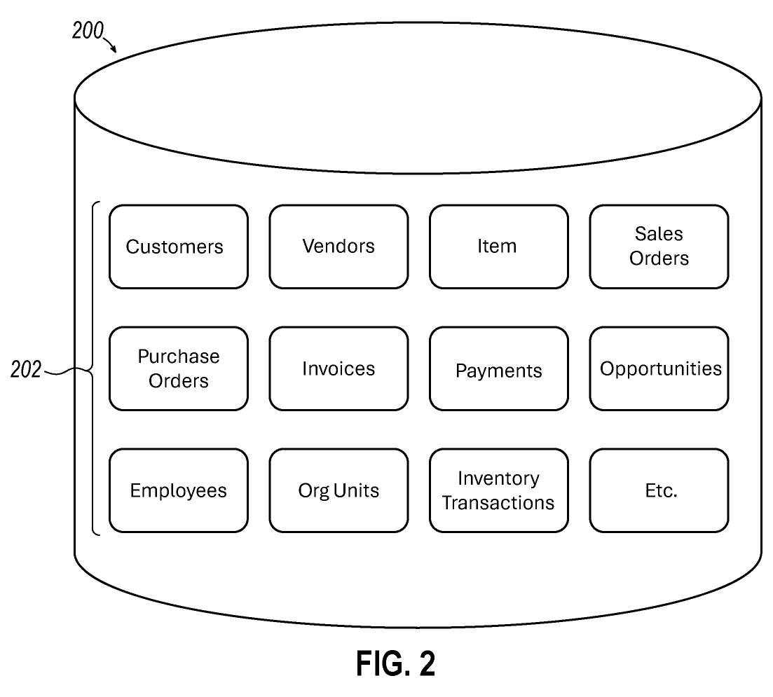

FIG. 2 illustrates one embodiment of the common data model 200 within the data management server 104 as described in FIG. 1. The common data model may contain normalized data from varying enterprise systems as described above. This normalized data may be further organized within the common data model according to business purpose. For example, in a sales-based environment, the common data model may be divided into subcategories 202. These subcategories 202 may include customers, vendors, item, sales orders, purchase orders, invoices, payments, opportunities, employees, organization units, inventory transactions, or other subcategories. These subcategories may be their own SQL table or other data structure. Some data within the subcategories may relate to each other and be stored accordingly. For example, a customer may place an order that requires payment. So, the customer information may be saved under the customers subcategory and associated with the sales orders subcategory, which may house details on the order itself. The status of payment from the customer for that particular order may be stored in the payments subcategory which may be associated with both the sales order and the customer. This may allow for wholistic storage of business data and the interactions between varying data.

Several functionalities offered by e.g., data integration system 100 include: normalization and integration of data into a common model, AI/ML business process task completion, and customized data alerts. Several possible embodiments of these processes or functionalities are described below.

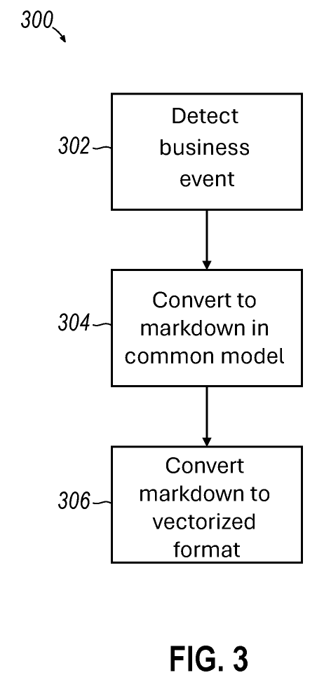

Normalization and Integration of Data into a Common Model: FIG. 3 illustrates one embodiment of a method 300 for normalizing structured data. With reference to FIG. 1, data management server 104 may monitor the varying enterprise systems 102 such that the data management server 104 can detect business events 302. Business events may include new client intake, new orders, updated order status, updated payment status, new opportunities, employee addition/promotion/ termination, or other updates to the structured data. The data management server 104 may trigger this method 300 for normalization of data when data is updated within one or more of the varying enterprise systems 102, added to the varying enterprise systems 102, or otherwise changed within the one or more varying enterprise systems 102. The data in the varying enterprise systems 102 may be synced with the data management server 104 at a predetermined interval; when data is updated, added, or removed; or at another predetermined event and/or trigger. Once a business event is detected 302, new or updated data may be converted to markdown format 304 by the data management server 104. If data is removed, the data management server may instead sync the common data model accordingly. The conversion to markdown format 304 may include identifying the structure of the data, mapping data elements to markdown syntax, and transforming the data into markdown syntax based on the original data format. For example, the structured data may be originally stored in hypertext transfer protocol (HTTP), secure file transfer protocol (SFTP), JavaScript object notation (JSON), extensible markup language (XML), representational state transfer (REST), simple object access protocol (SOAP), comma-separated values (CSV), electronic data interchange (EDI), or other formats. Then the markdown formatted data may be converted to a vectorized format 306 by the semantic search engine 106. The conversion to a vectorized format 306 may include preprocessing the markdown formatted data, tokenizing the text, embedding the tokens by converting the tokens into numerical vectors, indexing and storing the vectors according to the common data model 200, and implementing search algorithms such that the vectorized data can be used for semantic search.

The data integration system 100 may work autonomously to complete data entry as well, removing the need for a user to input redundant data into multiple enterprise systems 102. This may be similar to the data integration of FIG. 3, with an additional step between converting the data to markdown in the common data model 304 and converting the data from markdown format to vectorized format 306. This step may include the data management server 104 analyzing the new, changed, or removed data to determine which of the other varying enterprise systems 102 may be affected by that update/addition/removal and updating the other varying enterprise systems 102 accordingly. For example, if a user inputs a new order into an order management system, and the order management system is one of the varying enterprise systems 102, the data management server 104 may be triggered by the new information. The data management server 104 may then convert the new data to markdown format 304 such that it can be added to the common model 200. Then the data management server 104 may determine that the customers, sales orders, invoices, and payments subcategories were affected. The data management server 104 can then determine which of the varying enterprise data systems 102 are typically associated with elements in those subcategories and update them with the new data accordingly.

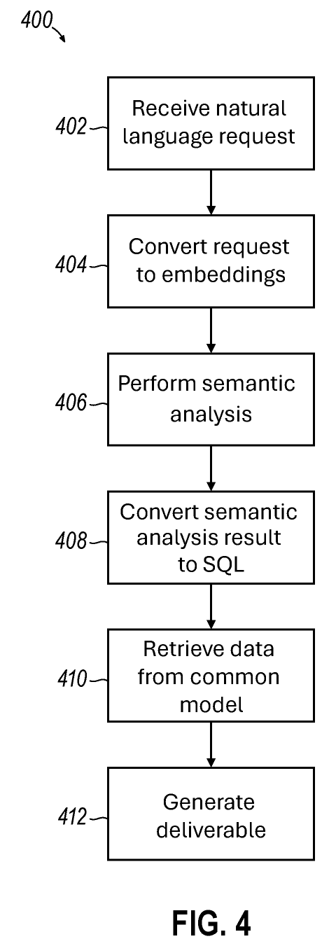

AI/ML Business Process Task Completion: Referring now to FIG. 4, one possible embodiment of a method 400 for generating a deliverable is shown. The business process platform API 108 may receive a natural language request 402 for completion of a task, answer to a question, or other task. For example, a request may be, “What is my current weighted sales pipeline grouped by stage, and can you organize that into a bar chart so I can download it for an upcoming presentation.” Another request may be “Create a new opportunity for Acme for a new project to streamline their widget building. We are hoping to close the deal by the first of May, and estimate this about a 20K deal.” Once the natural language request is received 402, the natural language request may be converted to embeddings 404 by the semantic search engine 106 such that semantic search may be used. This conversion to embeddings 404 may include preprocessing the natural language request; tokenizing the text; embedding the tokens by converting the tokens into numerical vectors and/or for larger chunks of text, generating embeddings that capture the context and meaning of entire sentences or paragraphs; indexing and storing the embeddings and/or vectors within the semantic search engine 106; and implementing search algorithms such that the embeddings and/or vectors can be used for semantic search. Then the semantic search engine 106 may perform semantic analysis 406 of the embeddings and/or vectors to determine how the embeddings and/or vectors may be grouped or classified based on their semantic properties. For example, the example Acme request above may be converted to embeddings then run through semantic analysis so the semantic search engine 106 can better understand how the new opportunity for Acme relates to the widget building, timeframe of the deal, cost estimate, and/or other relevant elements of the request. This can allow the semantic search engine to make meaningful connections between elements of the natural language request. The semantic analysis result can then be converted into SQL queries 408, or other queries, for semantic searching of the common data model 200. In some embodiments, semantic searching of the common data model 200 based on the natural language request may be done by performing a semantic search of the vectorized data within the common model using the embeddings and/or vectorized version of the natural language request. The queries may be used to retrieve data from the common data model 200, 410. From there, a deliverable may be generated 412 based on the data retrieved from the common data model 200, 410. The deliverable may be a graph, table, report, natural language explanation, report, draft email, or another deliverable.

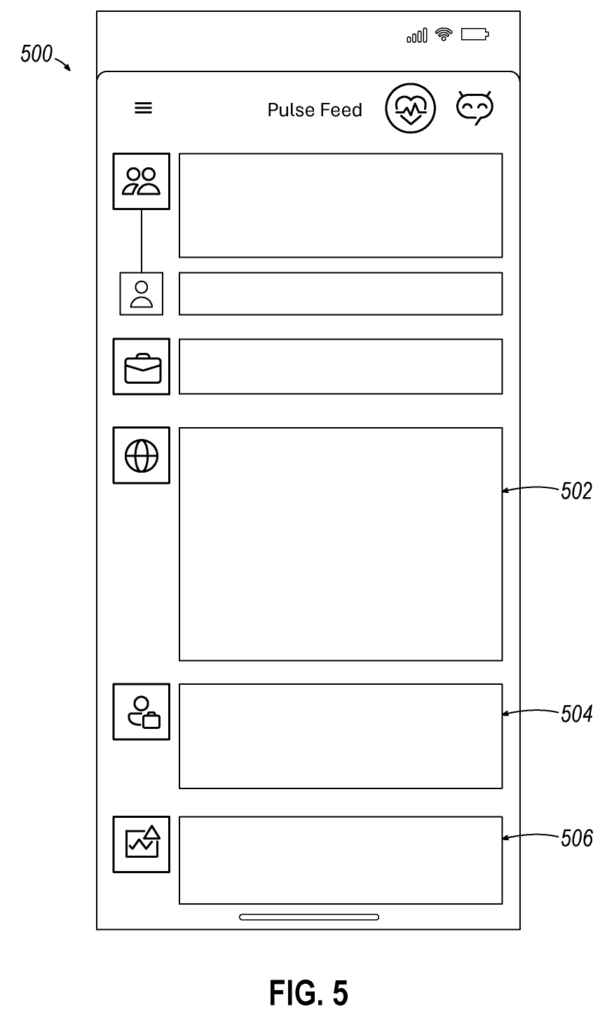

Customized Data Alerts: FIG. 5 illustrates an example user interface of a user feed 500 to be used with data integration system 100. The user feed 500 may include varying alerts and/or posts 502, 504, 506 from internal organizations and/or employees, public organizations and/or people, and may also include automated alerts which may include data alerts, user alerts, and/or other alerts. The user feed 500 may be an internal feed within an organization, customized to each user. This customization may be based on a user profile, which may include a user’s role in a company; a user’s typical interactions with particular systems, people, and/or clients; a user’s authorization level; a user’s location; and/or other user characteristics. The user profile may be generated and maintained by an AI/ML engine such that the profile can become more robust as time passes. The data integration system 100 may generate general user archetypes for particular roles such that more complex, customized user profiles can be generated based on the archetype. The user feed 500 may be available via an app, internal webpage, external data source, or other access point. The user feed 500 may be populated by messages from users within the organization, including customized messages sent to target groups, like marketing or IT (information technology). For example, the sales department may send a post 502 regarding a new distribution partner to the entire company or directly to the sales team only. These posts may be written by authorized users directly within the feed. Authorized users may be determined and assigned by the head of the department or other predetermined user(s). The user feed 500 may also be populated by the data management server 104 using data from the common data model 200. For example, an employee in sales may receive an alert 504 that provides sales numbers for the current month. This data may be pulled from the common data model and may be a general sales number for the sales team, but in some embodiments, this may be a sales number reflecting only the user’s sales. The user may also receive a quota progress alert 506 that reflects the user’s progress towards a monthly, or other, quota. Alerts may be determined by AI/ML engine 99. Users may also select types of alerts they want to receive, departments they want alerts from, alerts for various streams of data which may be specific to business areas relevant to their area of work, or other preferences for their feed. Users may also receive alerts customized based on their user profile such that the alerts are relevant to the user’s role, authorization level, location, and/or other characteristics. For example, a user in sales in a particular city may receive an alert regarding potential networking opportunities within the city relevant to the user’s field.

As described above, certain embodiments may incorporate AI/ML aspects.

### AI/ML Embodiments

Various embodiments under the present disclosure can incorporate AI/ML functionality. For example, for purposes of the present disclosure, business process platform API 108, data management server 104, and/or semantic search engine 106 of FIG. 1 can be said to comprise an AI/ML engine 99, either separately or together. Each component may comprise a separate instance of an identical AI/ML engine 99. Or a “central” AI/ML engine 99 could be running at any location, such as business process platform API 108, data management server 104, and/or semantic search engine 106, and others of the foregoing devices could function like an output/input interface to the central AI/ML engine 99, allowing user input, data collection, user interface for a user, etc. As described above, data management server 104 may collect data from varying enterprise systems 102, receive data from the semantic search engine 106, receive requests from users and/or AI agents, or otherwise receive or utilize a variety of other data. This data can be used to analyze what enterprise systems 102 and/or elements of the semantic search engine need to be updated, generate deliverables, generate custom alerts, or perform other types of tasks. This data can also be used to train AI/ML engine 99, or can be analyzed by a previously trained AI/ML engine 99.

It should be understood that AI/ML engine 99 can comprise one or more AI/ML engines. Commonly the terms machine learning engine or machine learning algorithm are used to refer to a specific algorithm. The term artificial intelligence commonly is used to refer to an entire system that achieves intelligence-like outcomes while using multiple sub-systems, such as multiple machine learning algorithms. But both ML and AI have been used to identify a variety of functionalities or types of systems that utilize various combinations of specific ML algorithms. As used herein, AI/ML engine is intended to denote a variety of AI/ML functionalities that fall under the category of AI or ML algorithms and systems that utilize such functionalities. Examples of AI/ML engine 99 can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing.

In data integration system 100 of FIG. 1, multiple AI/ML engines 99 can be used. For example, one AI/ML engine 99 can comprise a LLM-based chatbot that interacts with any user to gauge interests, receive requests, or perform other tasks. It may be that multiple different LLMs are used. For example, one LLM might be trained on distribution, marketing, sales, or other data from the enterprise systems 102. Another might be trained on external opportunities. A different AI/ML engine 99 may be stored or implemented at various of the components shown in FIG. 1. Alternatively, there may be a smaller number of AI/ML engines 99, and various of the components of FIG. 1 may function as user interfaces for a remote AI/ML engine 99 stored at e.g., data management server 104. Data used to train, retrain, or implement any of AI/ML engines 99 may be stored at any one or more of the components shown in FIG. 1. A person of ordinary skill in the art will recognize that a variety of such variations are possible under the present disclosure.

The architecture of an AI/ML engine 99 (e.g., structure, number of layers, nodes per layer, activation function etc.) may need to be tailored for each particular use case. For example, properties to vary can include e.g.: user characteristics (job title, department, goals, etc.), input enterprise system, data type, natural language request, and a variety of other factors. These may all need to be considered when designing an AI/ML engine 99 architecture.

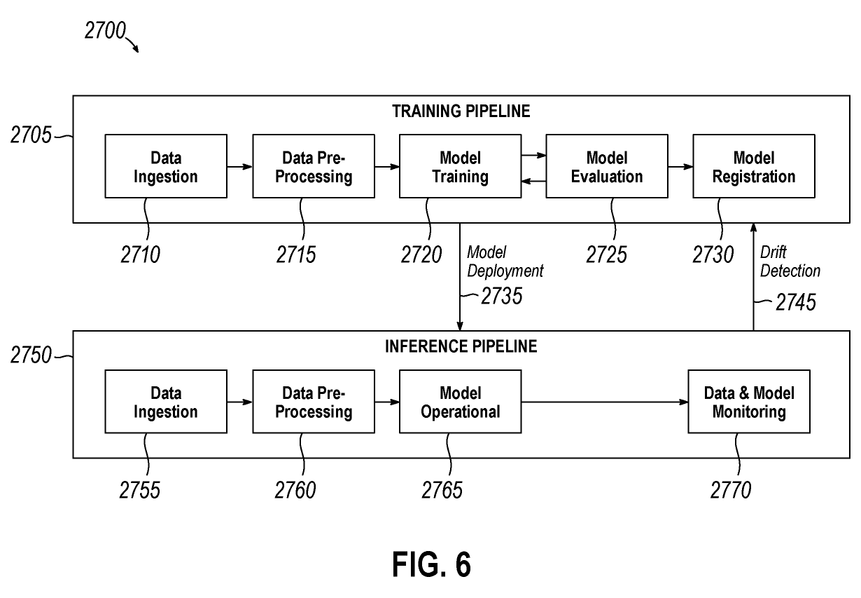

Building an AI/ML engine 99 can include several development steps where the actual training of a ML model or algorithm is just one step in a training pipeline. An important part in AI/ML development is AI/ML model lifecycle management. One embodiment of a model lifecycle management procedure 2700 is illustrated in FIG. 6. The model lifecycle management can in some embodiments comprise two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model’s architecture is fixed, it can be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model’s trainable parameters (e.g., the weights and biases of the underlying neural network (NN)) to minimize a loss function on the training datasets. The loss function may be, for example, based on maximizing consistency; minimizing task completion time; maximizing data accessibility, maximizing delivery in full and on time rate, maximizing throughput, minimizing freight cost per unit, maximizing carrier performance, maximizing forecast accuracy, maximizing order accuracy, maximizing perfect order rate, maximizing supplier performance, minimizing warehousing cost per unit, maximizing customer satisfaction, and/or other metrics. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model (e.g., AI/ML engine 99 of FIG. 1) is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., data integration system 100 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, typically comprises three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n + 1.

Parameter optimization: The gradients computed in the back propagation step are used to update the ML model’s trainable parameters. An approach is to use the gradient descent method with a learning rate hyperparameter (α) that scales the gradients of the weights and biases. It is preferred to make small adjustments to each parameter with the aim of reducing the average loss over the (mini) batch. It is common to use special optimizers to update the ML model’s trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user and/or a time to produce a result.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in data integration system 100 of FIG. 1 (e.g., in the form of simple vector-matrix multiplications).

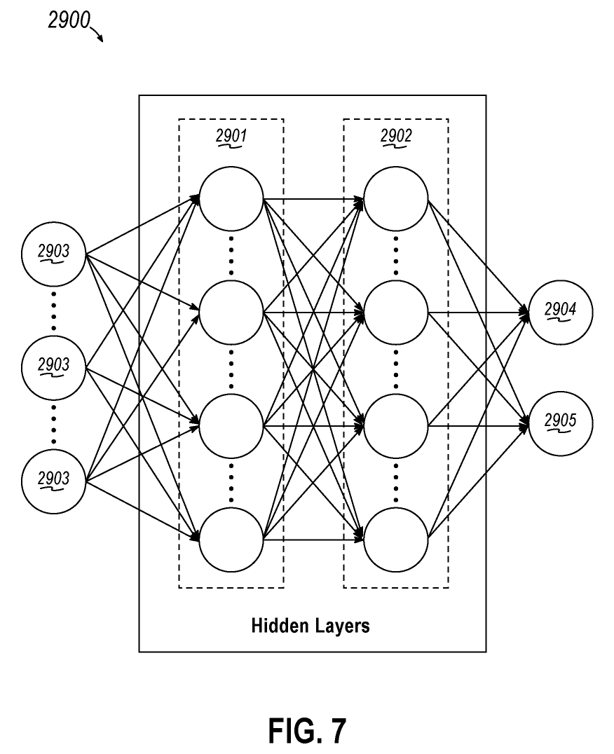

Referring now to FIG. 7, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2903 may go through a set of hidden layers (e.g., 2901 and/or 2902). Once the inputs 2903 pass though the hidden layers 2901 and/or 2902, they may be output (e.g., as an output layer) as outputs 2904, 2905. Outputs 2904, 2905 could be, e.g., a requested deliverable, a suggested alert, a natural language answer, data to be updated, a suggested action, a suggested solution, or another output variable. Possible inputs can include e.g.: user alert preferences, user characteristics (job title, department, goals, etc.), input enterprise system, data type, updated and/or new data, natural language request, forecast accuracy, order accuracy, perfect order rate, supplier performance, warehousing cost per unit, inventory turns, throughput, delivery in full and on time rate, freight cost per unit, carrier performance, and/or other variables.

As should be understood by one of ordinary skill in the art, in order for the NN 2900 to output proper a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

### ADDITIONAL EMBODIMENTS

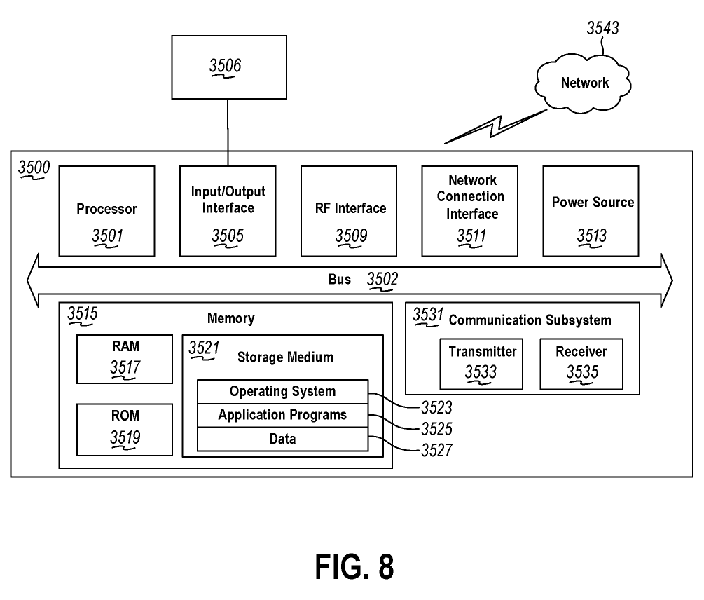

FIG. 8 illustrates an embodiment of various computing devices within data integration system 100 of FIG. 1, or components thereof e.g., business process platform API 108, data management server 104, and/or semantic search engine 106, which can comprise e.g., computers, tablets, servers, databases, mobile devices, or other computing or smart devices described herein. FIG. 8 shows a schematic block diagram of a computing device 3500 (or components thereof) according to certain embodiments of the present disclosure. System 3500 can be used to analyze and/or optimize: the functionalities described with respect to data integration system 100 of FIG. 1 and its components, or to perform other methods, such as AI or ML-related tasks and analyses as described herein.

Network 3543 includes Internet, cellular, Bluetooth^{TM}, Wi-FI, wired, wireless, satellite, enterprise, private network, similar networks, or combinations of the foregoing. Network 3543 may provide connectivity to one or more disparate and/or private data sources within a company or other entity, cloud and/or cloud data services, one or more disparate public data sources, and/or other sources.

Computing device 3500 includes processor 3501 that is operatively coupled via a bus 3502 to an input/output interface 3505, a power source 3513, a memory 3515, a RF interface 3509, network communication interface 3511, and/or any other component, or any combination thereof. The level of integration between the components may vary from one embodiment to another. Further, certain computing devices 3500 (or components thereof) may contain multiple instances of a component, such as multiple processors, memories, transceivers, transmitters, receivers, etc.

The processor 3501 is configured to process instructions and data and may be configured to implement any sequential state machine operative to execute instructions stored as machine-readable computer programs in memory 3515. Processor 3501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 3501 may include multiple central processing units (CPUs).

In the example, input/output interface 3505 may be configured to provide an interface or interfaces to an input/output device(s) 3506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 3500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, mobile device, wearable device, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 3513 is structured as a battery or battery pack. Other types of power sources, such as an external power source (e.g., an electricity outlet), photovoltaic device, or power cell, may be used. The power source 3513 may further include power circuitry for delivering power from the power source 3513 itself, and/or an external power source, to the various parts of computing device 3500 via input circuitry or an interface such as an electrical power cable.

Memory 3515 may be configured to include memory such as random access memory (RAM) 3517, read-only memory (ROM) 3519, programmable read-only memory (PROM), erasable programmable read-only memory (EPROM), electrically erasable programmable read-only memory (EEPROM), magnetic disks, optical disks, hard disks, removable cartridges, flash drives, other storage medium 3521, and so forth. In one example, the memory 3515 includes one or more application programs 3525, an operating system 3523, web browser application, a widget, gadget engine, or other application, and corresponding data 3527. Memory 3515 may store, for use by the computing device 3500, any of a variety of various operating systems or combinations of operating systems. An article of manufacture, such as one including a simulation system or communication system may be tangibly embodied as or in memory 3515, which may be or comprise a device-readable storage medium.

Processor 3501 may be configured to communicate with an access network or other network using the RF interface 3509 or network connection interface 3511. The RF interface 3509 or network connection interface 3511 may comprise one or more communication subsystems and may include or be communicatively coupled to an antenna. In the illustrated embodiment, communication functions of the RF interface 3509 or network connection interface 3511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Data integration system 100 of FIG. 1, or computing devices 3500 as described above or in regard to FIG. 1, can perform a variety of method embodiments under the present disclosure.

Although the computing devices described herein (e.g., servers, computing devices, etc. of data integration system 100 of FIG. 1) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in a network or computer system, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

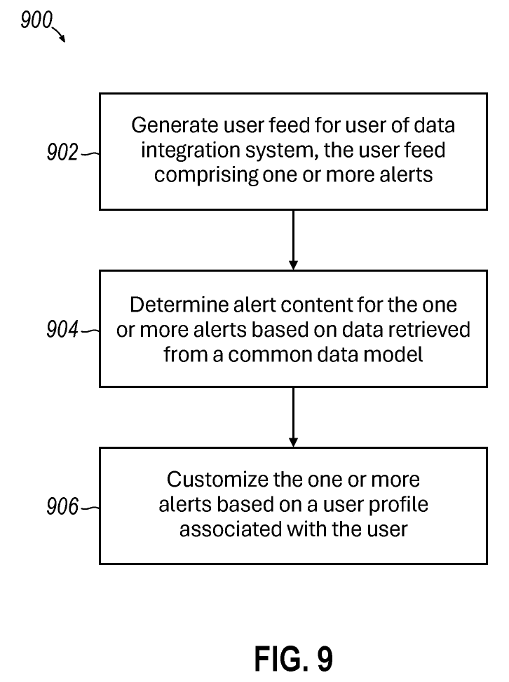

Referring now to FIG. 9, one embodiment of a method 900 for generating customized alerts in a user feed is shown. At step 902, the method 900 includes generating a user feed for a user of a data integration system, such as data integration system 100, the user feed comprising one or more alerts. At step 904, the method 900 includes determining alert content for the one or more alerts based on data retrieved from a common data model, such as common data model 200. At step 906, the method 900 includes customizing the one or more alerts based on a user profile associated with the user. In some embodiments, the user profile may comprise one or more of a role of the user in a company, typical interactions of the user with particular systems, people, or clients, an authorization level of the user, or a location of the user. In some embodiments, the method 900 may further comprise generating and maintaining the user profile using a machine learning engine, such as AI/ML engine 99. In some embodiments, the method 900 may further comprise generating a user archetype for a particular role and generating the user profile based on the user archetype. The user archetype may provide a baseline profile for users in similar roles, which can then be customized based on individual user characteristics and interactions over time.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### ABBREVIATIONS AND DEFINED TERMS

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10 %, or by less than 5 %, or by less than 1 %, or by less than 0.1 %, or by less than 0.01 % from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

A number of implementations have been described. Nevertheless, it will be understood that various modifications may be made without departing from the spirit and scope of the disclosure. Accordingly, other implementations are within the scope of the following claims.

### EXAMPLE EMBODIMENTS

Below are provided various possible, and non-limiting, embodiments under the present disclosure.

Example 1: A data management and integration system, comprising: a processor; and a memory storing instructions whereby the processor is configured to perform the steps of; detecting a business event in one or more enterprise systems; retrieving business event data from the one or more enterprise systems; converting the business event data to markdown formatted business event data; storing the markdown formatted business event data in a common data model; and converting the markdown formatted business event data to a vectorized format.

Example 2: A method performed by a data management and integration system, comprising: receiving a natural language request; converting the natural language request into embeddings; performing semantic analysis on the embeddings; converting a result of the semantic analysis to one or more SQL queries; retrieving data from a common data model by executing the one or more SQL queries; and if a deliverable is requested: generating a requested deliverable.

Example 3: The method of example 2, wherein the natural language request is a text-based request inputted by a user to an LLM.

Example 4: The method of example 2, wherein the natural language request is a text-based request from an AI agent.

Example 5: A computer implemented method for training a machine learning model for optimizing a data integration system, the method comprising: obtaining a dataset of identified task outcomes; training the machine learning model using the dataset of identified task outcomes thereby obtaining a trained machine learning model, and storing the trained machine learning model.

Example 6: The method of example 5, further comprising training a machine learning model for optimizing identified task outcomes, wherein the training comprises; training the machine learning model using a dataset of one or more identified task outcomes, thereby obtaining a further trained machine learning model; and storing the further trained machine learning model.

Example 7: The method of example 5 or 6, wherein the one or more identified task outcomes comprise one or more of: a requested deliverable, a suggested alert, a natural language answer, data to be updated.

Example 8: The method of any of examples 5 to 7, wherein the machine learning model uses one or more inputs comprising one or more of: user alert preferences, user characteristics, input enterprise system, data type, updated data, natural language request.

What is claimed is:

1. A data management and integration system, comprising:
a processor; and
a memory storing instructions that, when executed by the processor, cause the processor to:
detect a business event in one or more enterprise systems;
retrieve business event data from the one or more enterprise systems;
convert the business event data to markdown formatted business event data;
store the markdown formatted business event data in a common data model; and
convert the markdown formatted business event data to a vectorized format.

2. The system of claim 1, wherein the one or more enterprise systems comprise one or more of: a client relations management system; an enterprise resource planning system; an ecommerce system; a warehouse management system; or a human resource information system.

3. The system of claim 1, wherein the common data model comprises one or more data structures organized according to business purpose.

4. The system of claim 3, wherein the one or more data structures comprise subcategories including one or more of: customers; vendors; items; sales orders; purchase orders; invoices; payments; opportunities; employees; organization units; or inventory transactions.

5. The system of claim 1, wherein the business event comprises one or more of: new client intake; a new order; an updated order status; an updated payment status; a new opportunity; or an employee addition, promotion, or termination.

6. The system of claim 1, wherein converting the business event data to markdown formatted business event data comprises:
identifying a structure of the business event data;
mapping data elements to markdown syntax; and
transforming the business event data into markdown syntax based on an original data format.

7. The system of claim 1, wherein converting the markdown formatted business event data to the vectorized format comprises:
preprocessing the markdown formatted business event data;
tokenizing text within the markdown formatted business event data;
embedding tokens by converting the tokens into numerical vectors;
indexing and storing the numerical vectors according to the common data model; and
implementing search algorithms such that the vectorized format can be used for semantic search.

8. A method performed by a data management and integration system, comprising:
receiving a natural language request;
converting the natural language request into embeddings;
performing semantic analysis on the embeddings;
converting a result of the semantic analysis to one or more queries;
retrieving data from a common data model by executing the one or more queries; and
generating a deliverable based on the retrieved data.

9. The method of claim 8, wherein the natural language request is a text-based request inputted by a user to a large language model.

10. The method of claim 8, wherein the natural language request is a request from an AI agent.

11. The method of claim 8, wherein converting the natural language request into embeddings comprises:
preprocessing the natural language request;
tokenizing text within the natural language request; and
embedding tokens by converting the tokens into numerical vectors that capture context and meaning.

12. The method of claim 8, wherein performing semantic analysis on the embeddings comprises determining how the embeddings are grouped or classified based on semantic properties.

13. The system of claim 1, wherein the processor is further configured to: analyze the markdown formatted business event data to determine which of the one or more enterprise systems are affected by the business event; and update the affected enterprise systems based on the business event data.

14. The system of claim 13, wherein
updating the affected enterprise systems comprises determining subcategories of the common data model affected by the business event and identifying enterprise systems associated with the affected subcategories.

15. The system of claim 6, wherein the original data format comprises one or more of: hypertext transfer protocol (HTTP); secure file transfer protocol (SFTP); JavaScript object notation (JSON); extensible markup language (XML); representational state transfer (REST); simple object access protocol (SOAP); comma-separated values (CSV); or electronic data interchange (EDI).

16. A method for generating customized alerts, comprising:
generating a user feed for a user of a data integration system, the user feed comprising one or more alerts;
determining alert content for the one or more alerts based on data retrieved from a common data model; and
customizing the one or more alerts based on a user profile associated with the user.

17. The method of claim 16, wherein the user profile comprises one or more of: a role of the user in a company; typical interactions of the user with particular systems, people, or clients; an authorization level of the user; or a location of the user.

18. The method of claim 16, further comprising:
generating and maintaining the user profile using a machine learning engine.

19. The method of claim 16, further comprising:
generating a user archetype for a particular role; and
generating the user profile based on the user archetype.

20. A non-transitory computer-readable medium storing instructions that, when executed by a processor, cause the processor to perform the method of claim 8.
